(19) United States
(12) Patent Application Publication
(10) Pub. No.: US 2011/0224835 A1
(43) Pub. Date: Sep. 15, 2011

(54) INTEGRATED FLOW ASSURANCE SYSTEM

(75) Inventors: Morten Stenhaug, Sandsli (NO); Ali Razouki, Paris (FR); Luca Letizia, Abingdon (GB)

(73) Assignee: SCHLUMBERGER TECHNOLOGY CORPORATION, Sugar Land, TX (US)

(21) Appl. No.: 12/792,751

(22) Filed: Jun. 3, 2010

Related U.S. Application Data
(60) Provisional application No. 61/183,917, filed on Jun. 3, 2009.

(51) Int. Cl. G05D 7/00

(52) U.S. Cl. 700/282

(57) ABSTRACT

A flow assurance system comprising a plurality of flow assurance devices, each for performing a different flow assurance function. A platform device interfaces with the plurality of flow assurance devices to integrate the different flow assurance functions and enable a single point of entry of data for the flow assurances devices of the system.

### CROSS REFERENCE TO RELATED APPLICATIONS

The invention is related to and claims the benefit of priority from U.S. Provisional Patent Application Ser. No. 61/183,917 of Stenhaug et al., entitled “INTEGRATED FLOW ASSURANCE SYSTEM AND METHOD” filed on Jun. 3, 2009, the entire contents of which is hereby incorporated by reference herein.

### FIELD OF THE INVENTION

The present invention generally relates to systems and methods used for flow assurance, and more particularly to a system and method for flow assurance based on an integrated platform.

### BACKGROUND

Flow assurance (FA) is a term used in the oil and gas industry that refers to ensuring successful and economical flow of hydrocarbon stream from reservoir to the point of sale. Flow assurance is extremely diverse, encompassing many discrete and specialized subjects and bridging across the full gamut of engineering disciplines. Besides network modeling and transient multiphase simulation, flow assurance involves effectively handling many solid deposits, such as gas hydrates, asphaltene, wax, scale, and naphthenates. However, the present systems and methods used for flow assurance do not properly address existing challenges and technology gaps, for example, including data and model continuity, risk appraisal and management, speed of applications and their openness, and surveillance and data mining.

### SUMMARY OF THE INVENTION

Therefore, there is a need for a method and system that addresses the above and other problems with conventional systems and methods for flow assurance (FA). The above and other needs and problems are addressed by the exemplary embodiments of the present invention, which provide a flow assurance method and system, including an integrated flow assurance platform based on leading technologies combined with novel devices to fill the current industry technology gaps. Advantageously, a complete flow assurance capability is provided, including standardization of FA workflows, resulting in faster training of consultants, and making consultants operational as quickly as possible. In addition, because the range of skills provided by consultants is broad, the exemplary platform streamlines work processes, resulting in advantages not only in terms of training, but also in terms of productivity improvement. Further, continuity across disciplines and project timelines is provided to avoid information loss between disciplines and across the project timelines, resulting in greater accuracy in terms of design and risk assessment.

According to one aspect of the invention there is provided a flow assurance system comprising: a plurality of flow assurance devices, each for performing a different flow assurance function; a platform device for interfacing with the plurality of flow assurance devices to integrate the different flow assurance functions and enabling a single point of entry of data for the flow assurances devices of the system.

According to a further aspect of the invention there is provided a platform apparatus comprising: an interfacing unit for interfacing with a plurality of flow assurance devices each configured to perform a different flow assurance function; an input unit for enabling a user to input data; a data store for storing data either input by the user or operated on by the flow assurance devices; a processor for executing a computer program to enable the platform interface apparatus to be operated by the user, wherein the data in the data store is updated dynamically as the data is operated on by the flow assurance devices for providing a single point of entry of data for the flow assurances devices.

According to yet a further aspect of the invention there is provided a method of performing flow assurance, the method comprising: performing a plurality of different flow assurance functions using corresponding flow assurance devices; integrating the different flow assurance functions using a platform device for interfacing with the plurality of flow assurance devices and enabling a single point of entry of data for the flow assurances devices of the system.

Accordingly, in a further exemplary aspect of the present invention there is provided a system, method and computer program product for flow assurance (FA), including a fluids and solids modeling device, asphaltene, scale, asphaltene deposition, CO₂ corrosion, H₂S corrosion, chloride stress corrosion, and/or erosion modeling; a production engineering simulation and modeling device, including reservoir, steady and transient state, production facilities, and/or economic simulation and modeling; a production surveillance device, including data acquisition and/or data mining; a production operations device, including process control, surface intervention, and/or downhole operations management; a dynamic data store device for storing system operational data; and a subsea FA device coupled to the fluids and solids modeling, the production engineering, the production surveillance, and the dynamic data store devices. The subsea FA device provides an interface for sending and receiving information between and integrating the devices, and the system, method and computer program product are configured as integrated platform including a single point of entry of data for the devices.

Still other aspects, features, and advantages of the present invention are readily apparent from the entire description thereof, including the figures, which illustrates a number of exemplary embodiments and implementations. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIGS. 1-2 are used to illustrate industry challenges, based on capabilities of exemplary industry tools;

FIGS. 3A-3C are used to illustrate an exemplary system and method for flow assurance, based on an integrated platform;

FIGS. 4A-4C illustrate exemplary devices of the flow assurance system and method of FIG. 3;

FIG. 5 is used to illustrate an exemplary flow assurance consulting expert system and method;

FIG. 6 is used to illustrate an exemplary web site structure for the flow assurance consulting expert system of FIG. 4; and

FIG. 7 is used to illustrate a flow assurance system according to an embodiment of the present invention.

### DETAILED DESCRIPTION

The present invention includes recognition that there are industry challenges and technology gaps with respect to flow assurance (FA) system and methods, including data and model continuity, risk appraisal and management, speed of applications and their openness, and surveillance and data mining. The above and other problems are addressed by an exemplary flow assurance platform that provides data and model continuity, avoiding data being lost during handovers and different disciplines using different fluid models, leading to inconsistencies and inaccurate designs. Advantageously, the integrated platform includes a single point of entry of data that is used along project timelines and across disciplines. The integrated platform includes various tools, from core tools to process tools, for example, that allow a process engineer to use the same pressure, volume, temperature (PVT) application used by a simulation or production engineer.

The present invention also includes recognition that there is a challenge with respect to risk appraisal and management along the field lifetime. For example, when a customer's confidence on a design is low, they are conservative in their risk taking approach, which leads to operating (opex) and capital (capex) requirements overspending. Advantageously, the integrated platform provides for more accurate design and risk assessment, and is supplemented with tools that calibrate and validate models, enhancing customer confidence on a design and helping to put in place the right measures for flow assurance risk management.

The present invention also includes recognition that there is a challenge with respect to speed and application openness. Currently, tools are not integrated, which poses a huge challenge for the flow assurance consultant. Advantageously, the integrated platform provides an open and integrated tool that is able to accept input from leading applications, and which can run parallel simulations to improve speed.

The present invention also includes recognition that there is a challenge with respect to surveillance and data mining. For example, by their nature, flow assurance issues occur along flowlines, and presently there is no tool on the market capable of managing data coming from flow assurance sensors, which are distributed along the flowline. Advantageously, the integrated platform combines subsea surveillance capabilities along with software development capabilities to address this challenge.

Accordingly, the integrated flow assurance platform provides for data and models continuity by providing a single entry for the input data such that there is no data loss between project phases handovers and across disciplines, fluid characterization and models consistency from pore to process, and dynamic simulation from pore to process (e.g., well, surface and process). The integrated flow assurance platform also provides for risk appraisal and management by providing accurate evaluation of the effect of all the flow assurance risks, models calibration and validation, and realistic risk prevention and mitigation measures. The integrated flow assurance platform provides speed and openness by providing quick, multi-case runs, coupled simulations speed, and applications openness to 3rd party products (e.g., VIP, PROSPER, OLGA, PVTSim, etc.). The integrated flow assurance platform also provides for surveillance and data mining by providing distributed flow assurance sensors surveillance data management and mining.

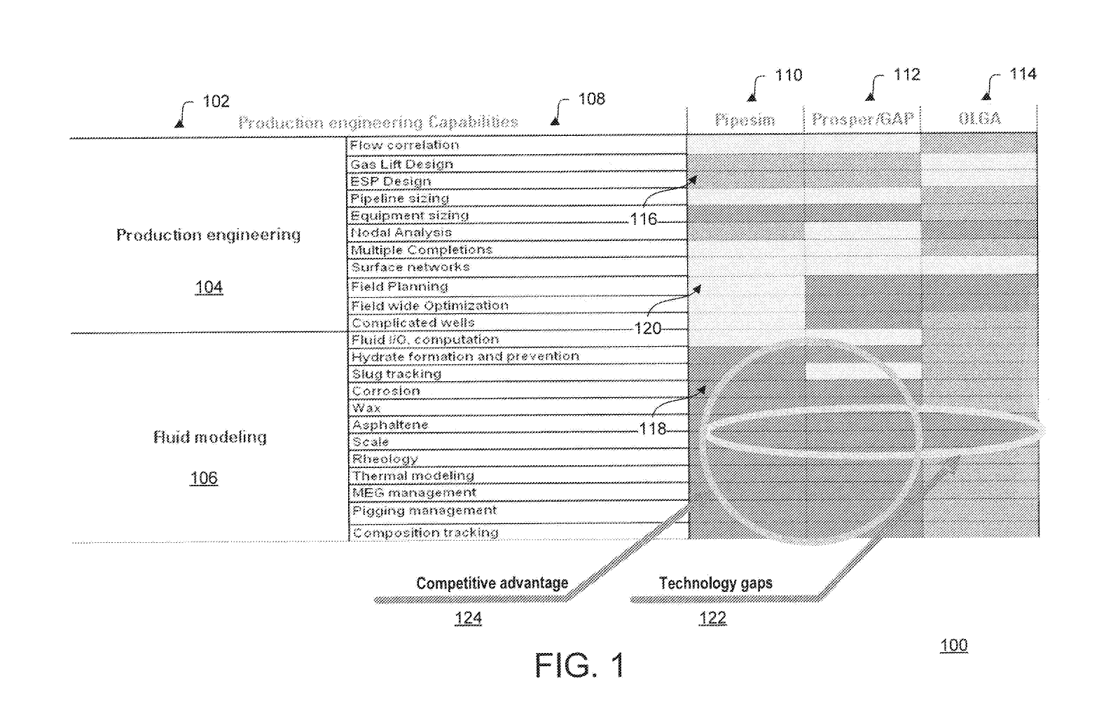

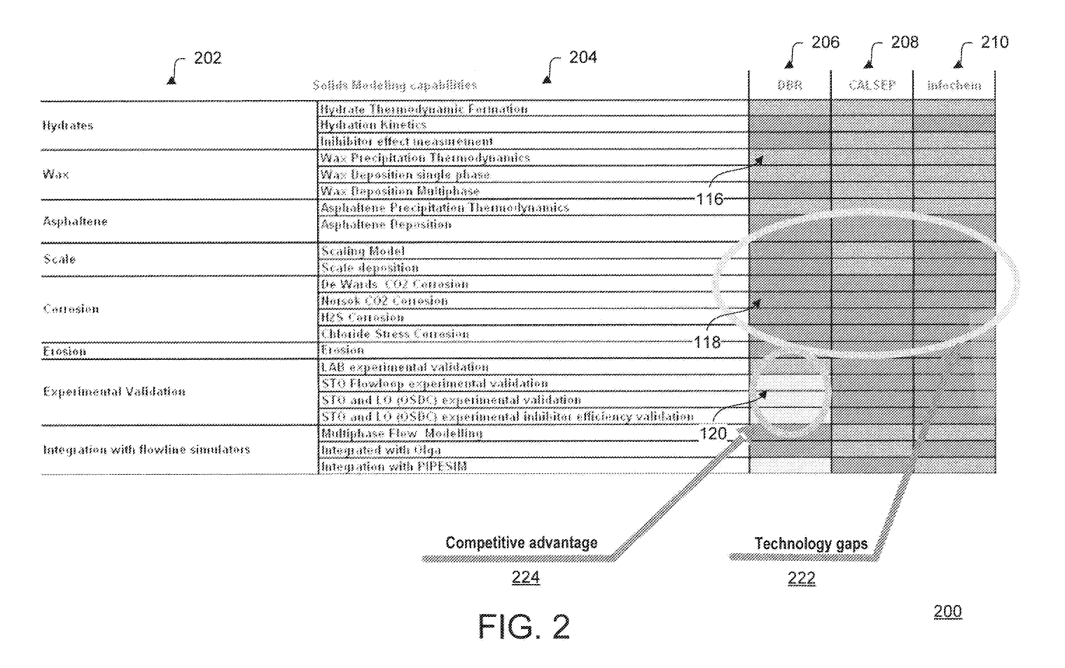

FIGS. 1-2 show the desired functionalities of the inventive method and system as well as point out the missing functionalities of existing exemplary systems that are offered commercially today. Production engineering is in the heart of any flow assurance (FA) workflow. FIG. 1 illustrates a capability matrix 100 for examining what the industry has to offer in the production engineering and fluid modeling domains. In FIG. 1, the first column 102 of the capability matrix 100 represents exemplary activities of a production engineer, including production engineering 104 and the impact of fluid modeling on production 106. The second column 108 is an exemplary list of the desired FA capabilities that the present inventive system offers. In FIG. 1, cells 116 (e.g., which can be shown in green) generally indicate a capability that is readily found in existing tools and systems 110 (A), 112 (B), and 114 (C) (e.g., systems such as PIPESIM available from Schlumberger, PROSPER/GAP available from Petroleum Experts, OLGA available from SPT Group, etc.). The cells 118 (e.g., which can be shown in red) generally indicate a missing capability in the existing systems.

The present inventive method and system is designed to allow embedding in an overall system platform existing commercially available systems 110 (A), 112 (B), and 114 (C). For example, the system 114 (C) is mainly used in transient state simulation, but generally lacks steady state fluid modeling capabilities. Accordingly, the present exemplary platform provides an integrated system for flow assurance including transient and steady state modeling capabilities that are not presently available with existing systems. Thus, the present invention fills a technology gap 122 and provides a competitive advantage 124 with respect to existing tools. For example, one technology gap or missing functionality 122 filled by the exemplary platform includes fluid modeling 106, with respect to scale and asphaltene deposition, and the like. Other newly created and novel functionalities are further described with respect to FIGS. 1-2, such as the coupling of reservoir studies to surface pipeline facility studies in real time, transient state conditions simulation and modeling, and the like.

FIG. 2 is used to illustrate additional functionalities of the inventive method and system with respect to solids modeling capabilities, which also are advantageous in any flow assurance (FA) study. In FIG. 2, a capability matrix 200 is provided for examining what the industry has to offer in the solids modeling domain, wherein the first column 202 represent the main solids modeling capabilities, the second column 204 provides details for the capabilities 202, and wherein experimental validation (e.g., for dead oil or live oil) and integration with the production tools (e.g., steady state or transient) are advantageous. The capabilities 204 are shown with respect to the corresponding solids modeling tools and systems 206 (D), 208 (E), and 210 (F) (e.g., systems such as DBR available from Schlumberger, CALSEP available from Calsep International Consultants, Infochem available from Infochem Computer Services, etc.). For example, the tool 208 is a dominant tool and is integrated with the tool 114, and the tool 210 focuses mainly on niche capabilities. Cells 116 (e.g., which can be shown in green) indicate a capability of the respective tool, cells 118 (e.g., which can be shown in red) indicate a missing capability of the respective tool, and cells 120 (e.g., which can be shown in yellow) indicate a possible capability of the respective tool.

From FIG. 2, it can be seen that all the tools 206-210 have similar technology gaps 222, and which are advantageously provided by the exemplary platform. For example, the tool 206 is missing advantageous capabilities, and none of the tools provide a full experimental validation capability, and none of the tools are integrated to a steady state simulator and transient simulator. Thus, the exemplary platform fills the technology gap 222 and provides a competitive advantage 224 with respect to the noted tools 206-210.

In summary, with respect to the technology gaps for production engineering, none of the steady-state simulators and tools provides a full flow assurance capability. Similarly, with respect to the technology gaps for fluids modeling, none of the fluid modeling software and tools are complete and lack integration with production engineering tools. With respect to the technology gaps for model validation with experimental data, existing fluid modeling software or tools are generally validated or calibrated by experimental data. In addition, the technology gaps with respect to workflows include fluid characterization inconsistency and discontinuity, and simulation workflows being done in silos. Advantageously, the exemplary platform fills the note technology gaps, as further described herein.

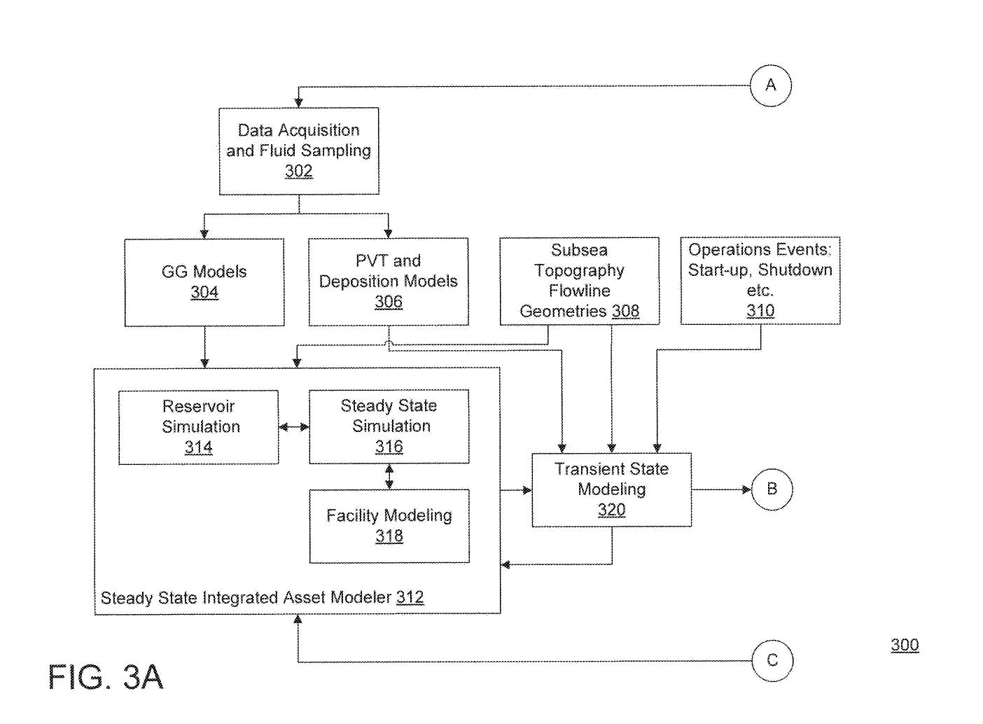

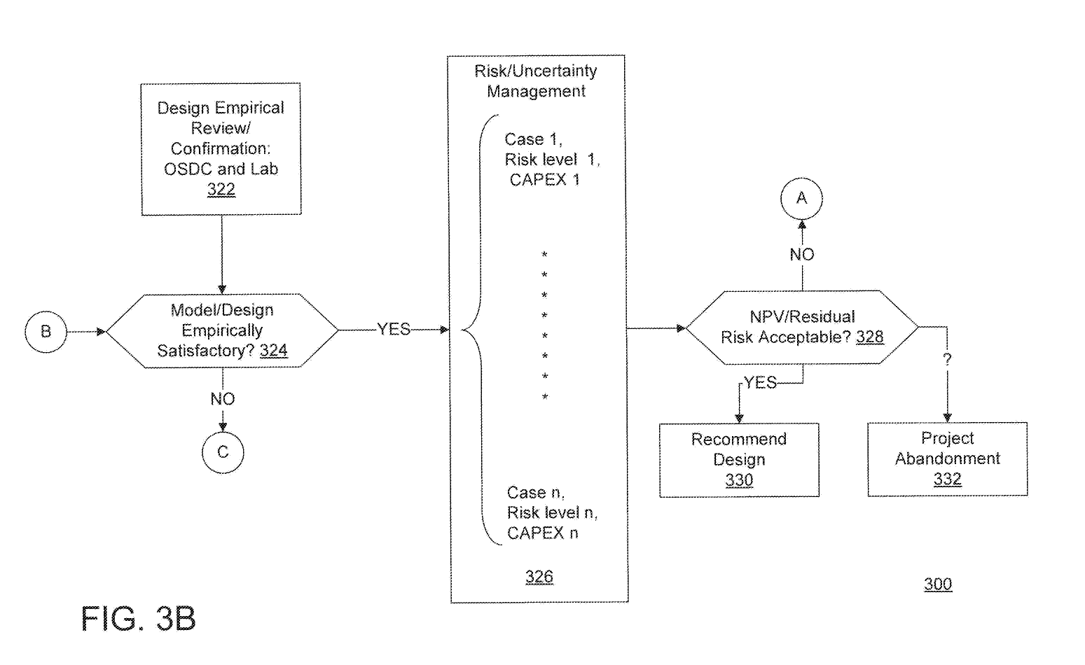

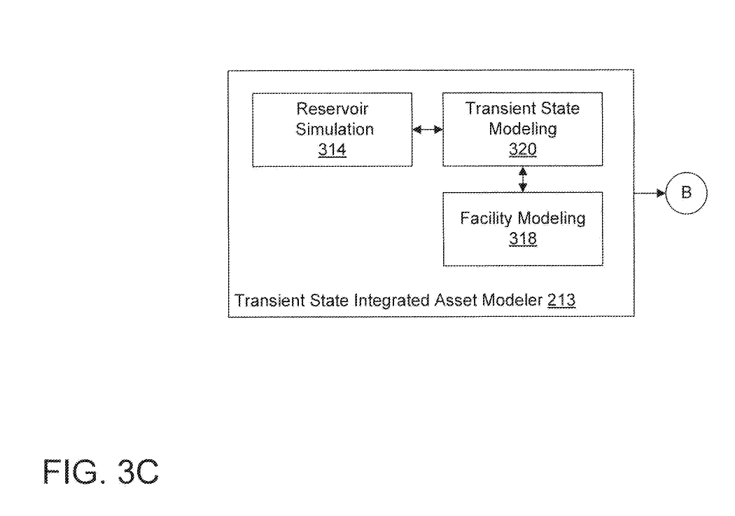

FIGS. 3A-3C are used to illustrate an exemplary system and method 300 for flow assurance, based on an integrated platform. In FIGS. 3A-3C, the exemplary system and method 300 can include a data acquisition and fluid sampling device 302; a geology and geophysics models device 304; a pressure/volume/temperature (PVT) models device 306; a subsea topography flowline geometries device 308; an operations events (e.g., start-up and shutdown) device 310; a steady state integrated asset modeler device 312 having a reservoir simulation device 314, a steady state simulations device 316 and a facility modeling device 318; a transient state modeling device 320; a design empirical review/confirmation (e.g., organic solids and deposition control (OSDC) and Lab) device 322; a step 324 to determine if a model/design is empirically satisfactory; a risk/uncertainty management device 326; a step 328 to determine if a negative predictive value (NPV)/residual risk is acceptable; a step 330 for design recommendation; and a step 332 for project abandonment.

In FIGS. 3A-3C, the data acquisition and fluid sampling device 302 performs data acquisition and fluid sampling functions, based on step 328 determining that the negative predictive value (NPV)/residual risk is not acceptable, and provides data acquisition and fluid sampling output information to the geology and geophysics models device 304 and the pressure/volume/temperature (PVT) models device 306. The steady state integrated asset modeler device 312 performs its functions (e.g., the reservoir simulation device 314, the steady state simulations device 316, the facility modeling device 318 functions), based on step 324 determining that the model/design is not empirically satisfactory, and provides steady state integrated asset modeling output information to the transient state modeling device 320. The steady state integrated asset modeler device 312 receives transient state modeling information from the transient state modeling device 320, geology and geophysics modeling information from the geology and geophysics models device 304, and subsea topography flowline geometry information from the subsea topography flowline geometries device 308.

The transient state modeling device 320 receives pressure/volume/temperature (PVT) modeling information from the pressure/volume/temperature (PVT) models device 306, subsea topography flowline geometry information from the subsea topography flowline geometries device 308, and operations events (e.g., start-up and shutdown) information from the operations events device 310, and provides transient state modeling information to step 324 for determining if the model/design is empirically satisfactory. Step 324 also receives design empirical review/confirmation (e.g., organic solids and deposition control (OSDC) and Lab) information from the design empirical review/confirmation device 322 for determining if a model/design is empirically satisfactory. If step 324 determines that the model/design is empirically satisfactory, control is transferred to the risk/uncertainty management device 326 to perform risk/uncertainty management (e.g., for case 1, risk level 1, CAPEX 1; . . . case n, risk level n, CAPEX n). The risk/uncertainty management device 326 provides risk/uncertainty management information to step 328 for determining if a negative predictive value (NPV)/residual risk is acceptable. If step 328 determines that a negative predictive value (NPV)/residual risk is acceptable, then the design can be recommended at step 330. If step 328 cannot determine that a negative predictive value (NPV)/residual risk is acceptable or is not acceptable, then the project can be abandoned at step 332.

FIG. 3C illustrate a transient state integrated asset modeler 313 coupling simulation, wherein the data from the reservoir modeling 314 are used as a boundary condition for the transient pipeline and well modeling 320, and vice versa. The reservoir simulation 314 can be run with various parameters, such as for a suitable short timestep, with various flow rates, PVT temperature and pressure, any suitable combination thereof, and the like, and can be provided to the pipeline and well transient simulator 320 as boundary conditions. The pipeline and well simulator 320 can be run for the same or with another timestep and the results (e.g., pressure, temperature, and flow rates, any suitable combination thereof, etc.) can be supplied to the reservoir simulator 314 as boundary conditions. This process can be repeated until the end of the coupled simulation is reached. The coupling can take place for the whole duration of the dynamic simulation. The simulation can be coupled to other data sources, for example, as described with respect to FIGS. 3A-3B.

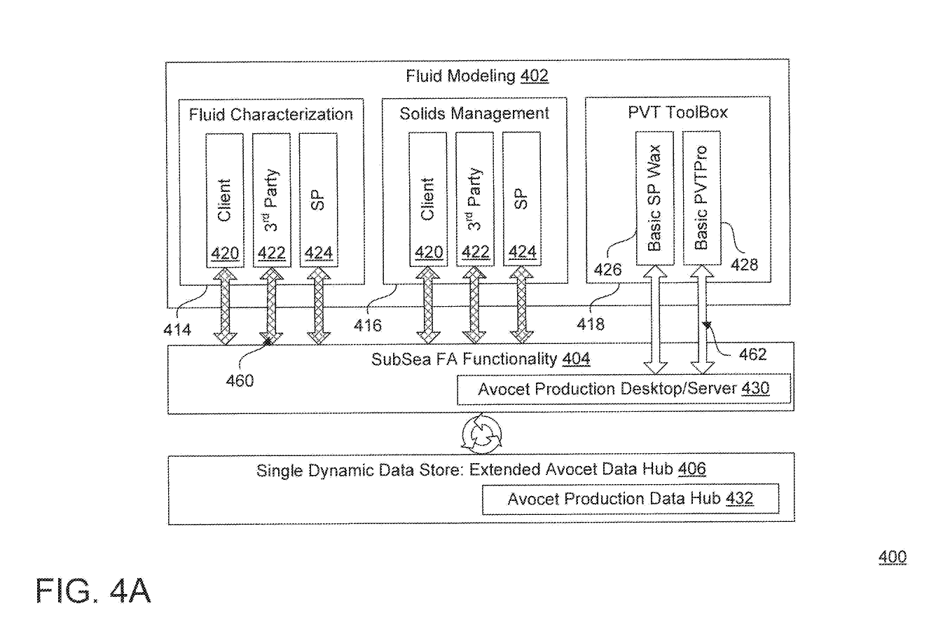

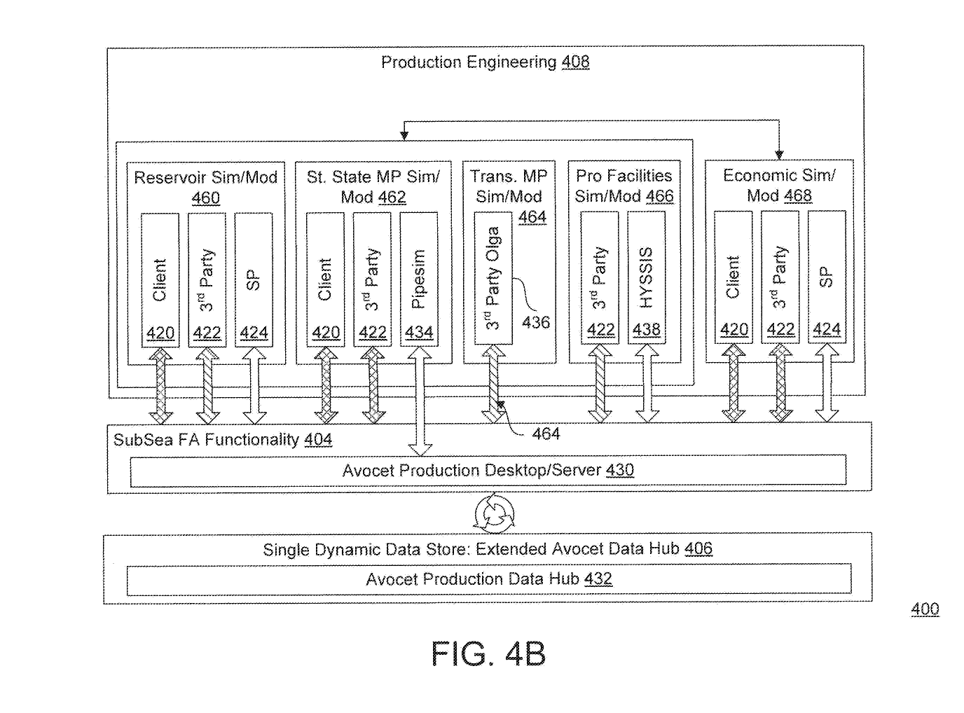

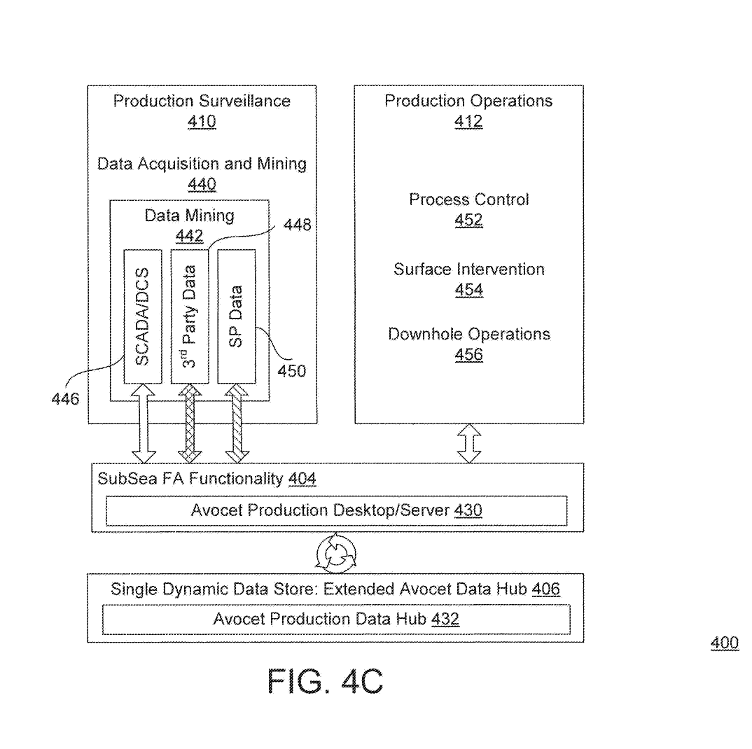

FIGS. 4A-4C illustrate exemplary devices of the flow assurance system and method of FIG. 3. In FIG. 4A-4C, the exemplary flow assurance system 400 can include a fluid modeling device 402, a subsea flow assurance (FA) device 404, a single dynamic data store device 406 (e.g., an extended Avocet data hub available from Schlumberger, etc.), a production engineering device 408, a production surveillance device 410, and a production operations device 412. The single dynamic data store device 406 can include a production data hub device 432 (e.g., an Avocet data hub, etc.). The subsea flow assurance (FA) device 404 and the single dynamic data store device 406 can interface with each other to provide a feedback loop throughout the exemplary system 400.

The fluid modeling device 402 can include a fluid characterization device 414, a solids management device 416, and a pressure/volume/temperature (PVT) toolbox device 418. The fluid characterization device 414 and the solids management device 416 can include respective client 420, third party 422 and service provider 424 devices. The PVT toolbox device 418 can include a wax fluid modeling device 426 (e.g., a basic SP Wax device, etc.) and a PVT modeling device 428 (e.g., a basic PVTPro device available from Schlumberger). The client 420, third party 422 and service provider 424 devices include respective application programming interfaces (APIs), shown by arrows, for interfacing with the a subsea flow assurance (FA) device 404. Similarly, the device 426 and the device 428 include respective APIs, shown by arrows, for interfacing with a production desktop/sever (e.g., Avocet) device 430 of the subsea flow assurance (FA) device 404.

The production engineering device 408 can include a reservoir simulation/modeling device 460, a steady state MP simulation/modeling device 462, a transient MP simulation/modeling device 464, a production facilities simulation/modeling device 466, and an economic simulation/modeling device 468, wherein the devices 460-466 interface with the device 468. The reservoir simulation/modeling device 460 and economic simulation/modeling device 468 can include respective client 420, third party 422 and service provider 424 devices. The steady state MP simulation/modeling device 462 can include client 420, and third party 422 devices and an off-the-shelf (OTS) device 434 for steady-state, multiphase flow simulation (e.g., PIPESIM, etc). The transient MP simulation/modeling device 464 can include a third party device 436 for multiphase flow and flow assurance (e.g., OLGA, etc.). The production facilities simulation/modeling device 466 can include third party 422 and an off-the-shelf device 438 for process modeling (e.g., HYSYS available from AspenTech, etc.). The client 420, third party 422, service provider 424, third party 436, and off-the-shelf 438 devices include respective application programming interfaces (APIs), shown by arrows, for interfacing with the subsea flow assurance (FA) device 404. Similarly, the off-the-shelf device 434 includes an API, shown by an arrow, for interfacing with the production desktop/sever device 430 of the subsea flow assurance (FA) device 404.

The production surveillance device 410 can include a data acquisition and mining device 440, including a data mining device 442. The data mining device 442 can include supervisory control and data acquisition (SCADA)/distributed and supervisory control systems (DCS) data 446, third party data 448, and service provider data 450 devices. The SCADA/DCS data 446, third party data 448, and service provider data 450 devices include respective application programming interfaces (APIs), shown by arrows, for interfacing with the subsea flow assurance (FA) device 404.

The production operations device 412 can include a process control device 452, a surface intervention device 454, and a downhole operations device 456. The production operations device 412 includes an application programming interface (API), shown by an arrow, for interfacing with the subsea flow assurance (FA) device 404. In FIGS. 4A-4C, the APIs are shown with cross-hatched arrows 460 for cases where the API is available, with blank arrows 462 for cases where the API is probably available, and with hatched arrows 464 for cases where the API is probably not available.

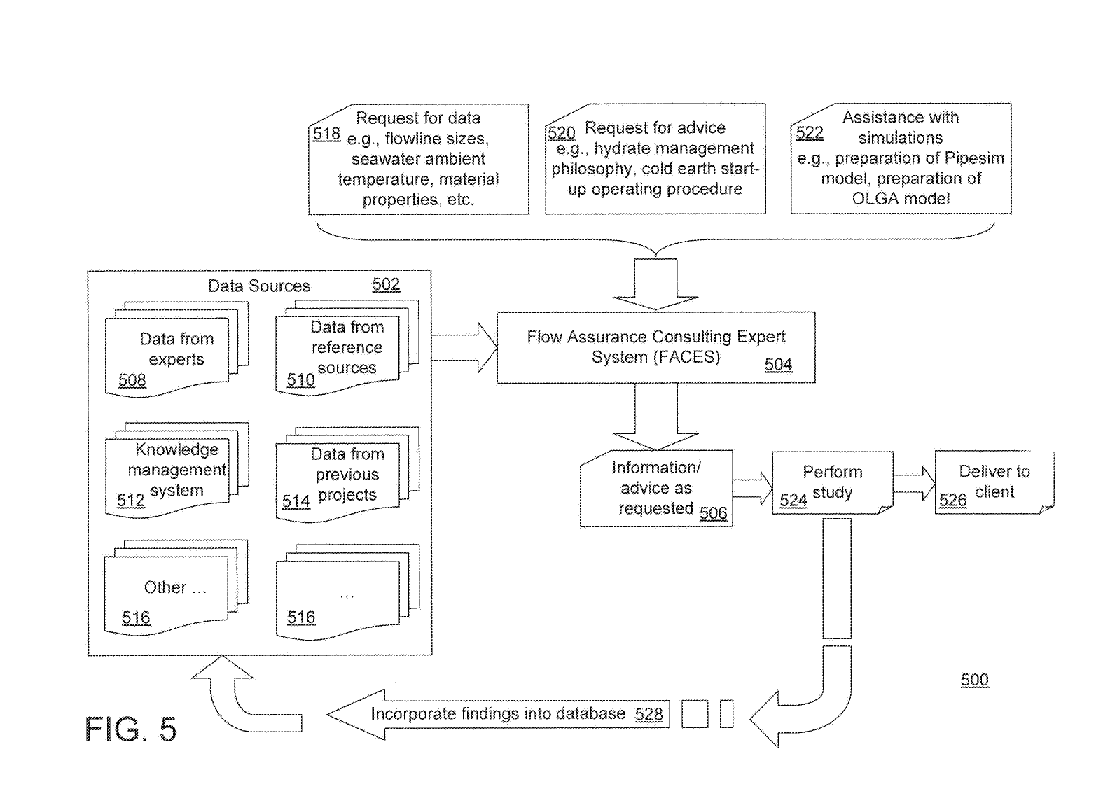

FIG. 5 is used to illustrate an exemplary flow assurance consulting expert system (FACES) and method 500. In the context of the exemplary embodiments, an expert system can include software and/or hardware that attempt to reproduce the performance of one or more human experts, for example, in a specific problem domain. In FIG. 5, the exemplary system and method 500 can include a device 502 for managing data sources, a FACES device 504, and an information/advice as requested device 506. The data sources device 502 can include a device 508 for managing data from experts, a device 510 for managing data from reference sources, a knowledge management system device 512, a device 514 for managing data from previous projects, and any other suitable devices 516. The FACES device 504 receives information from the device 502 based on a request 518 for data (e.g., for flowline sizes, seawater ambient temperature, material properties, etc.), a request 520 for advice (e.g., hydrate management philosophy, cold earth start-up operating procedure, etc.), and a request 522 for assistance with simulations (e.g., preparation of PIPESIM model, preparation of OLGA model, etc.). The FACES device 504 then provides the requested information/advice as step 506, which can be used to perform a study at step 524 for delivery to a client at step 526. Step 528 incorporate the findings from the performance of the study at step 524 into a database of the device 502 for managing the data sources.

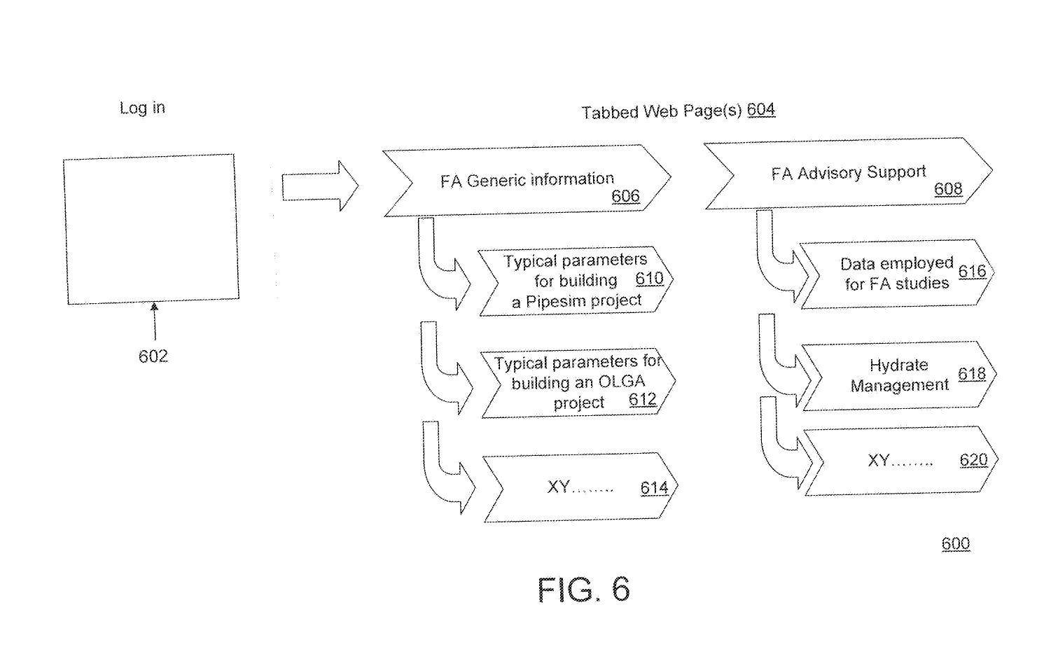

FIG. 6 is used to illustrate an exemplary web site 600 structure for the flow assurance (FA) consulting expert system of FIG. 5. In FIG. 6, the exemplary web site 600 can include a log in window 602 for logging in a user (e.g., based on secure personal credentials) and thereafter providing (e.g., tabbed) web pages 604. The web pages 604 can include web pages 606 for providing flow assurance generic information, such as a web page 610 for providing information for typical parameters for building a project (e.g., a PIPESIM project, etc.); a web page 612 for providing information for typical parameters for building another project (e.g., an OLGA project, etc.); one or more other web pages 614 for providing further flow assurance generic information; and the like. The web pages 604 also can include web pages 608 for providing flow assurance advisory support, such as a web page 616 for providing data employed for FA studies; a web page 618 for providing hydrate management advisory support; one or more other web pages 620 directed to providing further flow assurance advisory support; and the like.

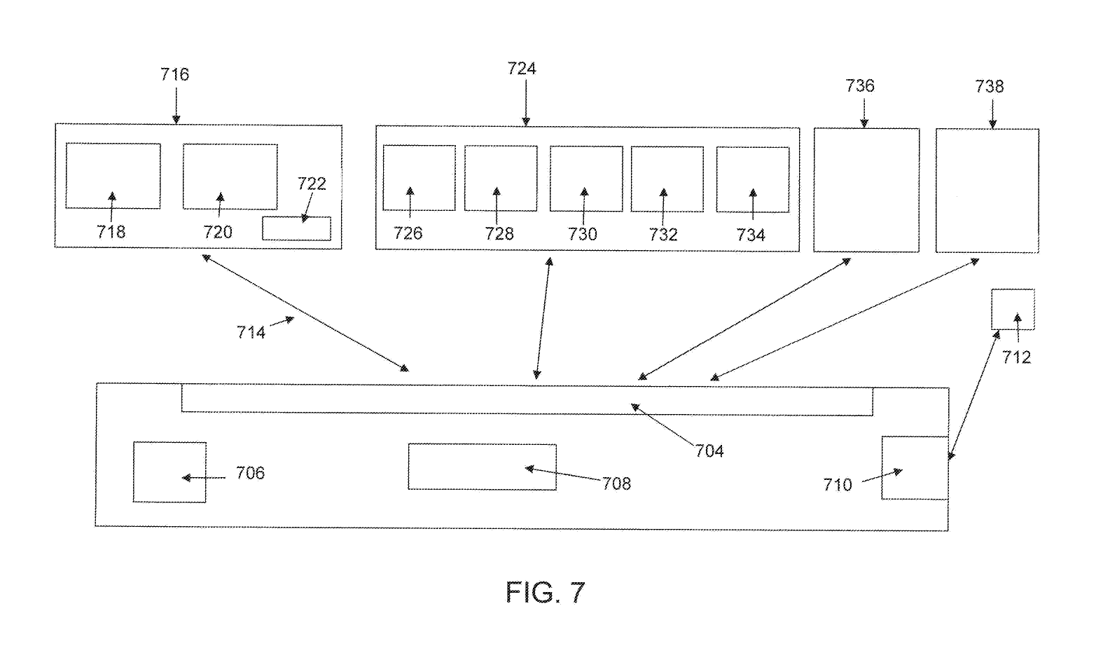

FIG. 7 shows a flow assurance system that integrates the functionality of various modules or devices according to an embodiment of the present invention. FIG. 7 shows a platform apparatus 702 having an interface unit 704 for interfacing with a plurality of flow assurance devices 718, 720, 726, 728, 730, 732, 734, 736 and 738. The platform apparatus also has a user interface 710 to communicate with a user. In one embodiment for example, the platform apparatus is located subsea, whereas the user is at a remote surface location. The platform apparatus is shown in the embodiment of FIG. 7 as having a data storage unit 706, but it should be appreciated that such data storage could be located externally as shown in FIG. 5, in which the data sources are all external to the flow assurance device. The platform apparatus 702 further having a computer processing unit 708, which is able to execute a computer program enabling the platform to be operated autonomously, or in the case of control by a user, from a remote location.

The platform apparatus 702 is able to interface with various flow assurance functions carried out by respective devices: i.e. the modeling device 716, production engineering device 724, production surveillance device 736 and production operations device 738.

The modeling device 716 may comprise different units itself such as a fluid characterization unit 718, a solids management unit 720 and a PVT toolbox 722. The production engineering device 724 also comprise further units each providing different functionality, such as the reservoir simulation/modeling unit 726, the steady state simulation/modeling unit 728, the transient state simulation/modeling unit 730, the production facilities simulation/modeling unit 732 and an economics simulation/modeling unit 734. The production surveillance device 736 is used for data acquisition and mining, for example by monitoring various sensors such as provided in SCADA or DCS systems. The production operations device 738 is capable of performing various production operation functions such as process control, surface intervention and downhole operations.

Thus, FIG. 7 shows how the platform device is able to interface with the various flow apparatus devices to provide a system having integrated functionality. Specifically, the data store 706 is dynamically updated to provide a single point of entry that provides for example data and model continuity. For example, if the PVT parameters 722 or one of the modeling devices 718, 720, 724 change—such a change is automatically and dynamically updated in the data storage unit 706—such that the new data is automatically available to the other flow assurance devices. This feedback loop ensures a single point of entry for data used by the different flow assurance devices. This advantageously for example avoids data being lost during handovers between disciplines that might use different fluid models, updates various stages along a project timeline and allows a process engineer to use the same pressure, volume, temperature (PVT) application used by a simulation or production engineer.

The above-described systems and devices of the exemplary embodiments can be accessed by or included in, for example, any suitable clients, workstations, PCs, laptop computers, PDAs, Internet appliances, handheld devices, cellular telephones, wireless devices, other devices, and the like, capable of accessing or employing the new architecture of the exemplary embodiments. The systems and devices of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the systems and devices of the exemplary embodiments are for exemplary purposes, as many variations of the specific hardware used to implement the exemplary embodiments are possible, as will be appreciated by those skilled in the relevant art(s). For example, the functionality of one or more of the systems and devices of the exemplary embodiments can be implemented via one or more programmed computer systems or devices.

To implement such variations as well as other variations, a single computer system can be programmed to perform the special purpose functions of one or more of the systems and devices of the exemplary embodiments. On the other hand, two or more programmed computer systems or devices can be substituted for any one of the systems and devices of the exemplary embodiments. Accordingly, principles and advantages of distributed processing, such as redundancy, replication, and the like, also can be implemented, as desired, to increase the robustness and performance of the systems and devices of the exemplary embodiments.

The systems and devices of the exemplary embodiments can store information relating to various processes described herein. This information can be stored in one or more memories, such as a hard disk, optical disk, magneto-optical disk, RAM, and the like, of the systems and devices of the exemplary embodiments. One or more databases of the systems and devices of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the systems and devices of the exemplary embodiments in one or more databases thereof.

All or a portion of the systems and devices of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the systems and devices of the exemplary embodiments can be implemented on the World Wide Web. In addition, the systems and devices of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the systems and devices of the exemplary embodiments, for driving the systems and devices of the exemplary embodiments, for enabling the systems and devices of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the systems and devices of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of the appended claims.

What is claimed is:

1. A flow assurance system comprising:
a plurality of flow assurance devices, each for performing a different flow assurance function;
a platform device for interfacing with the plurality of flow assurance devices to integrate the different flow assurance functions and enabling a single point of entry of data for the flow assurances devices of the system.

2. The system of claim 1, wherein the platform device is a subsea platform device.

3. The system of claim 1 wherein the interfacing is performed by sending and receiving information.

4. The system of claim 1 wherein each of the plurality of flow assurance devices is configured for performing at least one of the flow assurance functions of: modeling, simulating, monitoring, controlling and storage.

5. The system of claim 4, where the modeling comprises at least one of: modeling of a solid; modeling of a fluid; modeling of a reservoir; modeling of a steady state, modeling of a transient state; modeling of a production facility and modeling of economics of the system.

6. The system of claim 4, wherein the simulation comprises at least one of simulation of a reservoir, simulation of a steady state, simulation of a transient state, simulation of a production facility and simulation of economics of the system.

7. The system of claim 4, wherein the monitoring comprises a production surveillance device for performing at least one of a data acquisition and a data mining function.

8. The system of claim 4, wherein the controlling a production operations device for performing at least one of a process control, surface intervention, and a downhole management operation.

9. The system of claim 4, wherein the storage comprises a dynamic data store device for storing system operational data.

10. The system of claim 1, wherein the plurality of flow assurance devices comprise at least some of:
a fluids modeling device for modeling at least one of scale and asphaltene deposition;
a solids modeling device for modeling at least one of asphaltene deposition, carbon dioxide (CO₂) corrosion, hydrogen sulphide (H₂S) corrosion, chloride stress corrosion and erosion modeling;
a production engineering modeling device for, including at least one of reservoir simulation and modeling, steady state simulation and modeling, transient state simulation and modeling, production facilities simulation and modeling, and economic simulation and modeling;
a production surveillance device, including at least one of data acquisition and data mining;
a production operations device, including at least one of process control, surface intervention, and downhole operations management; and
a dynamic data store device for storing system operational data.

11. A platform apparatus comprising:
an interfacing unit for interfacing with a plurality of flow assurance devices each configured to perform a different flow assurance function;
an input unit for enabling a user to input data;
a data store for storing data either input by the user or operated on by the flow assurance devices;
a processor for executing a computer program to enable the platform interface apparatus to be operated by the user, wherein the data in the data store is updated dynamically as the data is operated on by the flow assurance devices for providing a single point of entry of data for the flow assurances devices.

12. The platform apparatus of claim 11, wherein the apparatus is at a subsea location and the user is at a remote surface location.

13. A method of performing flow assurance, the method comprising:
performing a plurality of different flow assurance functions using corresponding flow assurance devices;
integrating the different flow assurance functions using a platform device for interfacing with the plurality of flow assurance devices and enabling a single point of entry of data for the flow assurances devices of the system.

14. A computer implemented system for flow assurance, the system comprising:
a fluids and solids modeling device, including fluids modeling comprising at least one of asphaltene modeling and scale modeling, and solids modeling including at least one of asphaltene deposition modeling, CO₂ corrosion modeling, H₂S corrosion modeling, chloride stress corrosion modeling, and erosion modeling;
a production engineering simulation and modeling device, including at least one of reservoir simulation and modeling, steady state simulation and modeling, transient state simulation and modeling, production facilities simulation and modeling, and economic simulation and modeling;
a production surveillance device, including at least one of data acquisition and data mining;
a production operations device, including at least one of process control, surface intervention, and downhole operations management;
a dynamic data store device for storing system operational data; and
a subsea flow assurance device coupled to the fluids and solids modeling device, the production engineering device, the production surveillance device, and the dynamic data store device,
wherein the subsea flow assurance device provides an interface for sending and receiving information between and integrating the devices of the system, and
the system is configured as integrated platform including a single point of entry of data for the devices of the system.

15. A computer implemented method for flow assurance, corresponding to the system of claim 14.

16. A computer program product for flow assurance, corresponding to the method of claim 15.
